(19) United States
(12) Patent Application Publication
(10) Pub. No.: US 2015/0357071 A1
(43) Pub. Date: Dec. 10, 2015

(54) Core-Sheath Wire Electrode for a Wire-Cut Electrical Discharge Machine

(71) Applicant: Ya-Yang Yen, Taichung City (TW)

(72) Inventor: Ya-Yang Yen, Taichung City (TW)

(21) Appl. No.: 14/519,365

(22) Filed: Oct. 21, 2014

(30) Foreign Application Priority Data
Jun. 10, 2014 (TW) 103119990

(51) Int. Cl. H01B 1/02

(52) U.S. Cl. CPC H01B 1/023; H01B 1/026

(57) ABSTRACT

A core-sheath wire electrode for a wire-cut electrical discharge machine includes a metallic core of a metallic material, and a piezoelectric sheath surrounding the metallic core and made of a piezoelectric material of a metal compound. The metal compound includes zinc oxide, cadmium sulfide, or aluminum nitride, and has a hexagonal crystal structure or a face-centered cubic crystal structure.

### CROSS-REFERENCE TO RELATED APPLICATION

This application claims priority of Taiwanese Patent Application No. 103119990, filed on Jun. 10, 2014.

### FIELD OF THE INVENTION

This invention relates to a core-sheath wire electrode for a wire-cut electrical discharge machine, more particularly to a core-sheath wire electrode including a core and a piezoelectric sheath of a piezoelectric material.

### DESCRIPTION OF THE RELATED ART

U.S. Patent Application Publication No. 2011/0290531 discloses a conventional wire electrode for a wire-cut electrical discharge machine. The conventional wire electrode includes a metallic core of a metal or a metal alloy and a metallic covering that surrounds the metallic core and that includes one or more covering layers, of which at least one contains a phase mixture of β and/or β′ brass having a zinc content of about 45% by weight and y brass having a zinc content of about 53% by weight. The wire electrode has a tensile strength of about 750 N/mm² and an electrical conductivity of about 17 m/Ωmm².

During electrical discharge machining of a workpiece, the conventional wire electrode is disposed adjacent to the workpiece in a dielectric medium, such as water, so that controlled spark discharges are produced at a gap between the wire electrode and the workpiece through application of pulse voltages, which results in spark-erosion of the workpiece and formation of eroded bits from the workpiece. However, the bits eroded from the workpiece tend to accumulate at the gap between the wire electrode and the workpiece, which hinders the progress of spark-erosion of the workpiece and reduces efficiency of the eroding process.

The entire disclosure of U.S. Patent Application Publication No. 2011/0290531 is incorporated herein by reference.

### SUMMARY OF THE INVENTION

Therefore, an object of the present invention is to provide a core-sheath wire electrode for a wire-cut electrical discharge machine that can overcome the aforesaid drawback associated with the prior art.

According to this invention, there is provided a core-sheath wire electrode for a wire-cut electrical discharge machine. The core-sheath wire electrode comprises a metallic core of a metallic material, and a piezoelectric sheath surrounding the metallic core and made of a piezoelectric material of a metal compound.

### BRIEF DESCRIPTION OF THE DRAWINGS

In drawings which illustrate an embodiment of the invention,

FIG. 1 is a perspective view of the embodiment of a core-sheath wire electrode according to the present invention; and

FIG. 2 is a fragmentary partly sectional view of a wire electrode forming system for forming the core-sheath wire electrode according to the present invention.

### DETAILED DESCRIPTION OF THE EMBODIMENT

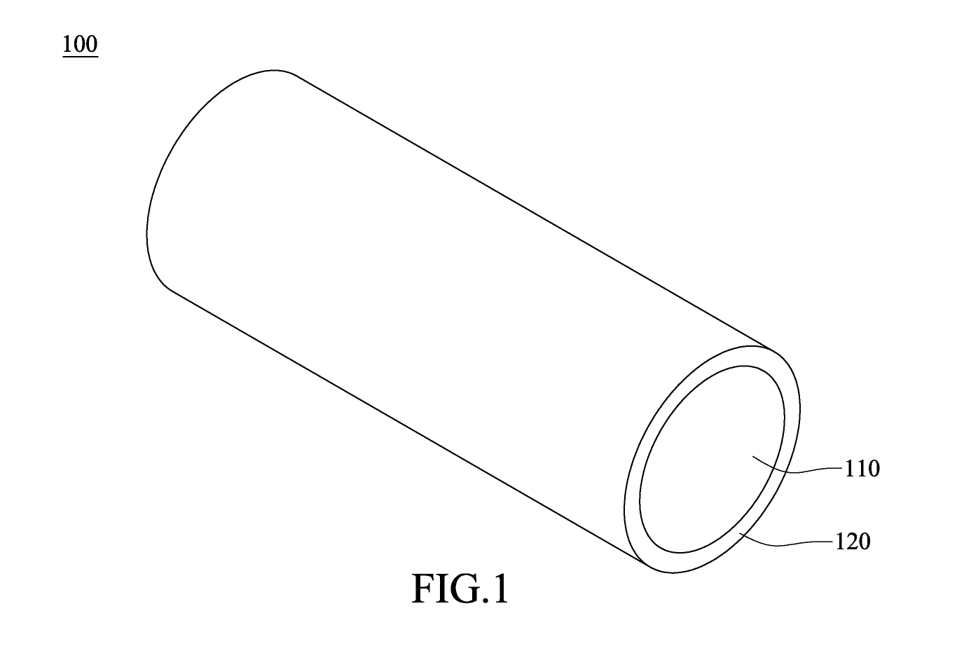

FIG. 1 illustrates the embodiment of a core-sheath wire electrode 100 for a wire-cut electrical discharge machine according to the present invention.

The core-sheath wire electrode 100 includes a metallic core 110 of a metallic material and a piezoelectric sheath 120 that surrounds the metallic core 110 and that is made of a piezoelectric material of a crystalline metal compound.

Preferably, the metal compound is selected from the group consisting of zinc oxide, cadmium sulfide, and aluminum nitride.

Preferably, the metal compound has a hexagonal crystal structure (e.g., Wurtzite crystal structure) or a face-centered cubic crystal structure (e.g., Zinc-blende crystal structure).

Preferably, the metallic material of the metallic core 110 is selected from the group consisting of copper, copper alloy, and steel, such as stainless steel. In one embodiment, the metallic core 110 may include an inner portion of a stainless steel, and an outer layer portion of copper or copper alloy surrounding the inner portion.

Preferably, the metallic core 110 has a diameter ranging from 100 μm to 3000 μm.

An embodiment of a method of making the core-sheath wire electrode 100 according to the present invention is illustrated as follows. The method comprises the steps of preparing a metallic wire which serves as the metallic core 110, forming a metal layer on the metallic wire so as to form a core-sheath wire preform, and converting the metal layer of the core-sheath wire preform into a piezoelectric layer of a crystalline metal compound exhibiting piezoelectric effect. The piezoelectric layer thus formed serves as the piezoelectric sheath 120 of the core-sheath wire electrode 100.

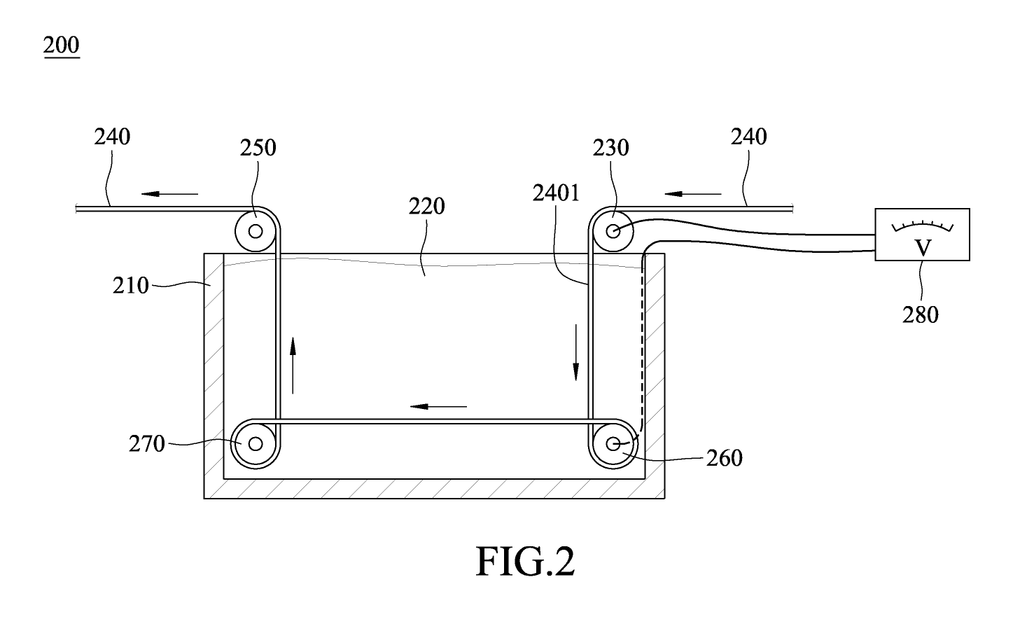

The conversion of the metal layer into the piezoelectric layer may be carried out by heating the metal layer of the core-sheath wire preform, followed by oxidizing the heated metal layer of the core-sheath wire preform using a wire electrode forming system 200 (see FIG. 2).

The wire electrode forming system 200 includes a liquid container 210 containing a liquid bath 220 of a dielectric liquid, a guiding roller unit configured to guide and bring a strip 240 of the core-sheath wire preform into, through and out of the liquid bath 220, and a motor (not shown) for driving movement of the strip 240 of the core-sheath wire preform. The guiding roller unit includes a conductive inlet-guiding roller 230, an outlet-guiding roller 250, a conductive first guiding roller 260, and a second guiding roller 270. Each of the inlet-guiding roller 230 and the first guiding roller 260 serves as a conductive guiding means. The first and second guiding rollers 260, 270 are immersed in the liquid bath 220. The inlet guiding roller 230 and the outlet guiding roller 250 are disposed above the liquid bath 220.

The heating of the metal layer of the core-sheath wire preform may be carried out by connecting the inlet guiding roller 230 and the first guiding roller 260 to a power source 280, followed by sliding the strip 240 of the core-sheath wire preform on the inlet-guiding roller 230 and the first guiding roller 260 and applying a potential difference between the inlet guiding roller 230 and the first guiding roller 260 using the power source 280 to cause short circuit therebetween through bridging of a portion 2401 of the strip 240 of the core-sheath wire preform disposed between the inlet guiding roller 230 and the first guiding roller 260, which results in heating of the portion 2401 of the strip 240. The strip 240 of the core-sheath wire preform is driven by the motor to move continuously and pass through the liquid bath 220, and the metal layer of the heated portion 2401 of the strip 240 of the core-sheath wire preform is immediately brought into reaction (i.e., the oxidation reaction, see infra) with the dielectric liquid in the liquid bath 220 and is cooled by the dielectric liquid. The strip speed of the strip 240 of the core-sheath wire preform may range from 100 m/min to 1600 m/min.

The heated metal layer of the core-sheath wire preform may be oxidized in the liquid bath 220 by reacting with the dielectric liquid that serves as an oxidant so as to form the piezoelectric layer. In one embodiment, the dielectric liquid is water, and the metal layer is made of zinc, so that through the short circuit between the inlet guiding roller 230 and the first guiding roller 260, the metal layer of the portion 2401 of the strip 240 may be heated to a temperature that is sufficient to permit reaction between zinc and water. As an example, the power source 280 may supply a current ranging from 5 A to 70 A through the portion 2401 of the strip 240 of the core-sheath wire preform for heating the latter.

The piezoelectric sheath 120 of the core-sheath wire electrode 100 exhibits converse piezoelectric effect, i.e. the piezoelectric sheath 120 can be actuated to vibrate (through repeated deformation and recovery of the piezoelectric material) when a pulse power is applied to the core-sheath wire electrode 100. Hence, when a workpiece (not shown) is machined in a dielectric medium using a wire-cut electrical discharge machine installed with the core-sheath wire electrode 100, the core-sheath wire electrode 100 may be actuated to vibrate due to the converse piezoelectric effect when a pulse power is applied to the core-sheath wire electrode 100 for performing the spark erosion of the workpiece, such that bits eroded from the workpiece during the machining may be quickly removed from a gap between the workpiece and the core-sheath wire electrode 100 by the vibration of the core-sheath wire electrode 100. Preferably, the frequency of the vibration of the piezoelectric sheath 120 or the core-sheath wire electrode 100 ranges from several hundred thousands times to several millions times per second so as to cause vigorous stirring of the dielectric medium at the gap between the workpiece and the core-sheath wire electrode 100, thereby resulting in generation of turbulence of the dielectric medium and fast removal of the bits eroded from the workpiece.

Preferably, the piezoelectric sheath 120 has a layer thickness ranging from 0.1 μm to 10 μm. If the layer thickness of the piezoelectric sheath 120 is too thin, such as less than 0.1 μm, the vibration amplitude (i.e., the degree of deformation) thereof during spark erosion may be too small to effectively remove the bits eroded from the workpiece. If the layer thickness of the piezoelectric sheath 120 is too thick, such as greater than 10 μm, the conductivity of the core-sheath wire electrode 100 may considerably decrease, which may result in generation of non-uniform arc or spark over the entire surface of the workpiece during spark erosion.

With the inclusion of the piezoelectric sheath 120 in the core-sheath wire electrode 100 of the present invention, the aforesaid drawback associated with the prior art may be eliminated.

While the present invention has been described in connection with what is considered the most practical embodiment, it is understood that this invention is not limited to the disclosed embodiment but is intended to cover various arrangements included within the spirit and scope of the broadest interpretation and equivalent arrangements.

What is claimed is:

1. A core-sheath wire electrode for a wire-cut electrical discharge machine, comprising:
a metallic core of a metallic material; and
a piezoelectric sheath surrounding said metallic core and made of a piezoelectric material of a metal compound.

2. The wire electrode of claim 1, wherein said metal compound is selected from the group consisting of zinc oxide, cadmium sulfide, and aluminum nitride.

3. The wire electrode of claim 2, wherein said metal compound is zinc oxide.

4. The wire electrode of claim 1, wherein said metal compound has a hexagonal crystal structure or a face-centered cubic crystal structure.

5. The wire electrode of claim 1, wherein said metallic material is selected from the group consisting of copper, copper alloy, and steel.

6. The wire electrode of claim 1, wherein said piezoelectric sheath has a layer thickness ranging from 0.1 μm to 10 μm.

7. The wire electrode of claim 1, wherein said metallic core has a diameter ranging from 100 μm to 3000 μm.
